(19) United States
(12) Patent Application Publication
(10) Pub. No.: US 2014/0232767 A1
(43) Pub. Date: Aug. 21, 2014

(54) DRIVING OF A COLOR SEQUENTIAL DISPLAY

(71) Applicants: Martin Hammer, Arendonk (BE); Teun Robert Baar, Paris (FR); Erno Hermanus Antonius Langendijk, Eindhoven (NL); Karel Johannes Gerhardus Hinnen, Eindhoven (NL); Yuning Zhang, Eindhoven (NL)

(72) Inventors: Martin Hammer, Arendonk (BE); Teun Robert Baar, Paris (FR); Erno Hermanus Antonius Langendijk, Eindhoven (NL); Karel Johannes Gerhardus Hinnen, Eindhoven (NL); Yuning Zhang, Eindhoven (NL)

(73) Assignee: TP VISION HOLDING B.V., Eindhoven (NL)

(21) Appl. No.: 14/343,490

(22) PCT Filed: Sep. 12, 2012
(86) PCT No.: PCT/EP2012/067827

§ 371 Date: Apr. 29, 2014

Related U.S. Application Data
(60) Provisional application No. 61/533,295, filed on Sep. 12, 2011.

(51) Int. Cl. G09G 3/36

(52) U.S. Cl. CPC G09G 3/3607
USPC 345/694; 345/102

(57) ABSTRACT

A display system comprises a color sequential display (201) having a backlight (205) comprising several backlight segments and a light modulating panel (207) comprising pixels having controllable light transmission. A backlight unit (211) determines, for a plurality of backlight segments, backlight chromaticities for fields of an image in response to the image content. An order unit (217) determines a sequential order of the backlight chromaticities for each of the plurality of backlight segments for the image in response to the chromaticities. A driver (219) generates a backlight drive signal for the backlight (205) corresponding to the chromaticities and sequential order. A modulating processor (213) determines light modulating values for the pixels in response to the chromaticities, the sequential order and the image. A driver (221) then generates a light modulating drive signal for the light modulating element corresponding to the light modulating values. The system may improve image quality by reducing spatial cross-talk between the backlight segments.

### FIELD OF THE INVENTION

The invention relates to color sequential displays and in particular, but not exclusively, to driving of color sequential displays having a variable color backlight and a liquid crystal light modulating panel.

### BACKGROUND OF THE INVENTION

The most common contemporary displays are displays having a backlight and a light modulating display panel. The backlight provides illumination incident on the light modulating display panel which comprises a number of pixels (and possibly sub-pixels) made from elements with a varying transparency or light transmission. The transparency of the elements can be controlled by electrical signals thereby allowing the light modulating display panel to be locally controlled such that the backlight is spatially modulated to provide an image.

A typical implementation of the light modulating display panel is by use of liquid crystal technology to provide small picture elements that can be controlled. Such an approach is for example known from LCD televisions.

Reproduction of colors is typically achieved by generating three (or possibly more) color primaries that are individually controlled for each pixel to provide the combination that corresponds to the desired color. The individual color components corresponding to the primaries are accordingly combined in the viewer's eyes to provide a perception of a single color point.

The individual color primaries may be separated spatially or temporally (or possibly both).

In the most widespread backlight matrix displays, each pixel is divided into three (or more) sub pixels each of which correspond to a different primary. Such displays typically include a color filter which ensures that the light incident on each subpixel has a desired chromaticity for the primary. Typical conventional matrix displays, such as LCDs, use red (R), green (G), and blue (B) primaries to represent color. Such displays thus comprise individual RGB subpixels and a corresponding color filter for each set of subpixels. Due to the small size of the subpixels, the color of the individual subpixels is not perceived but rather the combined color of the pixel is perceived.

Another type of displays is known as color sequential displays. In this type of displays, the different color primaries are provided in short sequential time intervals, also known as fields. Thus, a temporal division is provided for the primaries and by implementing this division sufficiently fast, the human visual system will combine the individual colors of the fields into a single perceived color. The different color primaries are in such displays typically achieved by using different colors for the backlight in the different fields (e.g. by introducing colored light sources). Thus, an advantage of color sequential displays is that the light modulating display panel has no color filters or color filters with broader transmission spectrum enabling an increased transmission. Secondly, the spatial requirements for a given pixel size may be relaxed substantially as no implementation of individual subpixels is needed. However, a disadvantage is that the temporal requirements are increased and that typically very fast switching is required in order to reduce temporally related image degradations.

Conventionally both spatial matrix displays and color sequential displays have used three fixed primary color values, and typically have used a red, green, and blue primary. In many displays such an approach is achieved using a fixed-intensity backlight of white color combined with color filters for each primary color, or without color filters, but with a fixed-intensity, temporally-switching and colored backlight corresponding to each primary. However, such implementations have a limited gamut and result in images with restricted colors and/or luminance. It furthermore tends to result in high power consumption by always using a fixed nominal backlight level.

Accordingly, displays have been developed that adaptively modify the primaries provided by the backlight for modulation by the light modulating display panel. In a simple example, the backlight may simply be dimmed for darker images in order to reduce power consumption. In other embodiments, the backlight level may temporarily be increased to extend the gamut from the nominal gamut. In more advanced displays it has been proposed to dynamically modify the color of the backlight primaries to dynamically adapt the available gamut to the image contents. In other advanced displays, it has been proposed to use more than three primaries. Such displays are known as multi-primary displays and may typically have four or even five or six primaries resulting in different gamuts.

In particular, a drawback of color-sequential LC-displays has been the presence of color-breakup artifacts. With relative motion between display and the human eye (observer), the sequentially displayed colors appear at different locations on the retina causing a very annoying colored triple-image effect.

While increasing the refresh rate of the display can reduce the visual artifact (preferably with a refresh rate of over 1000 Hz), this is currently impossible with state-of-the- art LC-panels due to slow electro-optical response.

To reduce the problem of color breakup, it has been proposed to dynamically vary the chromaticities of the backlight primaries by mixing the red, green, and blue light sources in each field to create (typically) less saturated field colors. This typically results in a perceived reduction in color break-up (colored triple-image effect).

In addition, it has been proposed to adapt the backlight locally rather than for the whole image. Thus, the adaptation of the backlight chromaticities may be applied to local regions of an image, similar to how local backlight dimming can modulate the backlight intensity This concept can be realized using an LC-display in combination with a backlight comprising a matrix of colored LEDs. An example of such an approach is described in F. -C. Lin, Y. Zhang, and E. H. A. Langendijk, “Color Breakup Suppression by Local Primary Desaturation in Field-Sequential Color LCDs”, IEEE J. of Display Technology, 7(2), 2011.

FIG. 1 illustrates an approach for driving such a prior art color sequential display. The image is fed to a backlight driver 101 which determines suitable chromaticity and luminance for the backlight primaries used in the backlight segments in the different fields of the color sequential frame for the image. The backlight driver 101 then generates a backlight drive signal which is fed to the backlight to provide the desired backlight in the individual fields and segments. The signal is further fed to a backlight evaluation processor 103 which proceeds to calculate the actual incident light on the individual pixels of the light modulating element. This takes into account the fact that light reaches the pixel from a plurality of backlight segments, i.e. it takes into account the spatial cross-talk between image segments. The image data and the calculated backlight for each pixel are further fed to an LC processor 105 which determines suitable values for the transmissitivity of the pixels of the light modulating panel (specifically the LC element). The pixel values are calculated such that the presented image most closely reflects the image data given the actual backlight distribution calculated by the backlight evaluation processor 103.

However, although it has been found that in some scenarios such an approach can substantially reduce the color-breakup artifact, it has also been found that it for some images results in suboptimal image quality and indeed may result in perceptible degradations and color breakups.

Hence, an improved approach would be advantageous and in particular an approach that would allow improved image quality, facilitated implementation, low complexity, increased flexibility, and/or improved performance would be advantageous.

### SUMMARY OF THE INVENTION

Accordingly, the Invention seeks to preferably mitigate, alleviate or eliminate one or more of the above mentioned disadvantages singly or in any combination.

According to an aspect of the invention there is provided an apparatus for driving a color sequential display having a backlight comprising a plurality of backlight segments and a light modulating panel comprising pixels having controllable light transmission for modulating light from the backlight, the apparatus comprising: a backlight unit for determining, for a plurality of backlight segments, backlight chromaticities for fields of at least one image to be displayed by the color sequential display in response to the at least one image; an order unit for determining a sequential order of the backlight chromaticities for each of the plurality of backlight segments for the at least one image in response to the chromaticities; a first driver for generating a backlight drive signal for the backlight corresponding to the chromaticities and the sequential order; a modulating processor for determining light modulating values for the pixels in response to the chromaticities, the sequential order and the at least one image; and a second driver for generating a light modulating drive signal for the light modulating panel corresponding to the light modulating values.

The invention may provide an improved driving of color sequential display. In particular, the invention may in many scenarios and for many images provide an improved color consistency and/or reduced color break-ups. For example, it may in many scenarios remove or reduce color breakup artifacts such as sharp lines in uniform regions. Furthermore, the approach may often achieve a more saturated image and may in particular for many images reduce image de-saturation caused by spatial cross-talk between different backlight segments displaying different colors in the same field. The approach may potentially reduce display flicker which may occur due to inconsistent field ordering between frames.

The approach may allow not only the spatial chromaticity of the backlight to be adapted to the specific image but may also provide a temporal arrangement of chromaticities in the different fields for the image such that an improved spatial consistency in each field can be achieved. Specifically, the spatial color variation between different backlight segments in the individual fields may be reduced.

Each of the chromaticities may correspond to a chromaticity of one backlight segment in one field. The image is presented by a plurality of time intervals in which one backlight primary is provided. Each field corresponds to a time interval. In each time interval, a backlight chromaticity (and optionally luminance) is typically set for each backlight segment and one light modulating value is typically supplied for each pixel. In each field, the backlight chromaticities and light modulating values are typically considered constant. The backlight chromaticities and light modulating values may (will typically) change between fields. Each field thus typically provides a primary color for the image with the gamut for the image being determined by the primary colors of the fields used for the image.

In addition to the chromaticity for the backlight segments, a backlight luminance may also be determined for the backlight segments.

In accordance with an optional feature of the invention, the order unit is arranged to determine the sequential order for a first backlight segment of the backlight segments in response to the chromaticities of a second backlight segment of the backlight segments.

This may in many embodiments and/or scenarios provide improved performance. In particular, it may for many images provide reduced color break-up. The sequential ordering may be based on relative chromaticities between the first and second backlight segments. The approach may in particular in many scenarios reduce spatial cross-talk between the first and second backlight segments. The second backlight segment may be a neighbor segment for the first backlight segment.

In accordance with an optional feature of the invention, the order unit is arranged to determine the sequential order for a first backlight segment of the backlight segments in response to the chromaticities of the first backlight segment.

This may in many embodiments and/or scenarios provide improved performance. In particular, it may for many images provide reduced color break-up.

In some embodiments, the sequential order for a first backlight segment may be determined in response to chromaticities of only the first backlight segment. This may in many embodiments allow a substantially reduced complexity and may reduce e.g. the computational load requirement.

In some embodiments, the sequential order for the first backlight segment may be determined in response to chromaticities of both the first backlight segment and a second backlight segment. This may in many embodiments allow improved image quality. The second backlight segment may be a neighbor segment for the first backlight segment. The sequential ordering may be based on relative chromaticities between the first and second backlight segments. The approach may in particular in many scenarios reduce spatial cross-talk between the first and second backlight segments.

In accordance with an optional feature of the invention, the order unit is arranged to determine the sequential order for a first backlight segment of the backlight segments in response to a comparison between the chromaticities of the first backlight segment and a chromaticity reference.

This may in many embodiments provide a particularly advantageous trade-off between image quality and complexity/ resource requirements. In particular, it may allow an efficient algorithm for determining a sequential order, for example by allowing the sequential order for each backlight segment to be determined based on the chromaticities of only the backlight segment.

In accordance with an optional feature of the invention, the chromaticity reference is a chromaticity point.

This may in many embodiments provide a particularly advantageous trade-off between image quality and complexity/ resource requirements.

In accordance with an optional feature of the invention, the chromaticity reference is a chromaticity vector.

This may in many embodiments provide a particularly advantageous trade-off between image quality and complexity/ resource requirements. In particular, it may avoid the need to determine absolute chromaticity differences.

In accordance with an optional feature of the invention, the order unit is arranged to determine the sequential in response to a spatial cross talk indication for at least two backlight segments of the backlight segments in at least one field.

This may in many embodiments and/or scenarios provide improved performance. In particular, it may for many images provide reduced color break-up.

In accordance with an optional feature of the invention, the order unit is arranged to determine the sequential order to minimize spatial cross talk between at least two backlight segments of the backlight segments in at least one field.

This may in many embodiments and/or scenarios provide improved performance. In particular, it may for many images provide reduced color break-up.

In accordance with an optional feature of the invention, the order unit is arranged to determine the sequential order in response to backlight chromaticities determined for other images than the at least one image.

This may allow improved image quality in many scenarios and may specifically allow improved temporal consistency across different images. The approach may in many scenarios reduce perceived image flicker. The other images may specifically be other images of an image sequence, such as a video sequence. The other images may specifically be neighbor images, such as images immediately preceding or following the at least one image.

In accordance with an optional feature of the invention, the order unit is arranged to determine the sequential order in response to sequential orders determined for other images than the at least one image.

This may allow improved image quality in many scenarios and may specifically allow improved temporal consistency across different images. The approach may in many scenarios reduce perceived image flicker. The other images may specifically be other images of an image sequence, such as a video sequence. The other images may specifically be neighbor images, such as images immediately preceding or following the at least one image.

In accordance with an optional feature of the invention, the apparatus further comprises a modification unit for modifying at least a first chromaticity of the chromaticities in response to the sequential order.

This may in many scenarios result in improved perceived image quality. For example, it may allow reduced de-saturation due to spatial cross talk between different backlight segments.

In accordance with an optional feature of the invention, the apparatus further comprises a modification unit for modifying a luminance associated with at least one of the chromaticities in response to the chromaticities.

This may in many scenarios result in improved perceived image quality. For example, it may allow reduced de-saturation due to spatial cross talk between different backlight segments. The modification may be an increase or a decrease of luminance, and may specifically be an increase for one of the chromaticities with a corresponding decrease for another of the chromaticities. The modification unit may specifically be arranged to switch off the backlight of one or more backlight segments in one or more fields.

In accordance with an optional feature of the invention, the apparatus further comprises a modification unit for modifying at least one of a luminance and a chromaticity for at least one of the chromaticities in response to the sequential order.

This may in many scenarios result in improved perceived image quality. For example, it may allow reduced de-saturation due to spatial cross talk between different backlight segments. The modification unit may specifically be arranged to switch off the backlight of one or more backlight segments in one or more fields.

In accordance with an optional feature of the invention, there is provided a color sequential display system comprising: a display having a backlight comprising a plurality of backlight segments and a light modulating panel comprising pixels having controllable light transmission for modulating light from the backlight; a backlight unit for determining, for a plurality of backlight segments, backlight chromaticities for fields of at least one image to be displayed by the color sequential display in response to the at least one image; an order unit for determining a sequential order of the backlight chromaticities for each of the plurality of backlight segments for the at least one image in response to the chromaticities; a first driver for generating a backlight drive signal for the backlight corresponding to the chromaticities and the sequential order; a modulating processor for determining light modulating values for the pixels in response to the chromaticities, the sequential order and the at least one image; and a second driver for generating a light modulating drive signal for the light modulating panel corresponding to the light modulating values.

According to an aspect of the invention there is provided a method of driving a color sequential display having a backlight comprising plurality of backlight segments and a light modulating panel comprising pixels having controllable light transmission for modulating light from the backlight; the method comprising: determining, for a plurality of backlight segments, backlight chromaticities for fields of at least one image to be displayed by the color sequential display in response to the at least one image; determining a sequential order of the backlight chromaticities for each of the plurality of backlight segments for the at least one image in response to the chromaticities; generating a backlight drive signal for the backlight corresponding to the chromaticities; determining light modulating values for the pixels in response to the chromaticities, the sequential order and the at least one image; and generating a light modulating drive signal for the light modulating panel corresponding to the light modulating values.

These and other aspects, features and advantages of the invention will be apparent from and elucidated with reference to the embodiment(s) described hereinafter.

### BRIEF DESCRIPTION OF THE DRAWINGS

Embodiments of the invention will be described, by way of example only, with reference to the drawings, in which

FIG. 1 is an illustration of a display driver for a color sequential display in accordance with prior art;

FIG. 2 is an illustration of an example of elements of a color sequential display system in accordance with some embodiments of the invention;

FIG. 3 illustrates an image divided into backlight segments;

FIG. 4 illustrates examples of backlight distributions for different fields of a color sequential display in accordance with some embodiments of the invention;

FIGS. 5 and 6 illustrates color points and gamuts of two segments of the image of FIG. 2;

FIGS. 7 and 8 illustrate examples of allocation of chromaticities to fields for two backlight segments in accordance with some embodiments of the invention; and

FIG. 9 is an illustration of an example of elements of a color sequential display system in accordance with some embodiments of the invention;

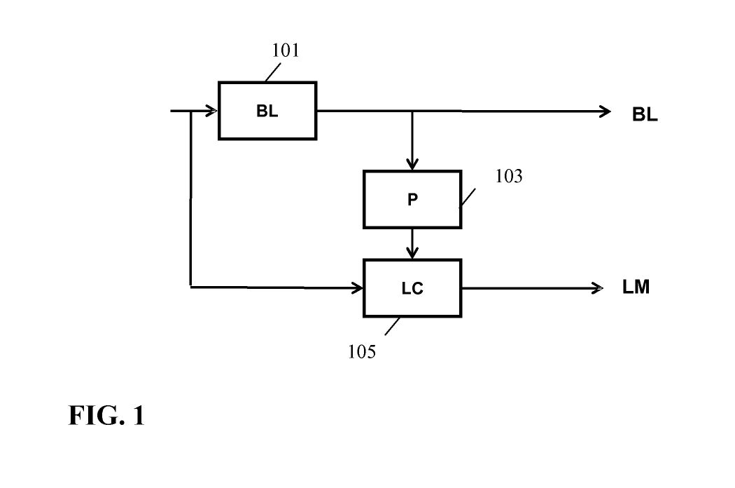

### DETAILED DESCRIPTION OF SOME EMBODIMENTS OF THE INVENTION

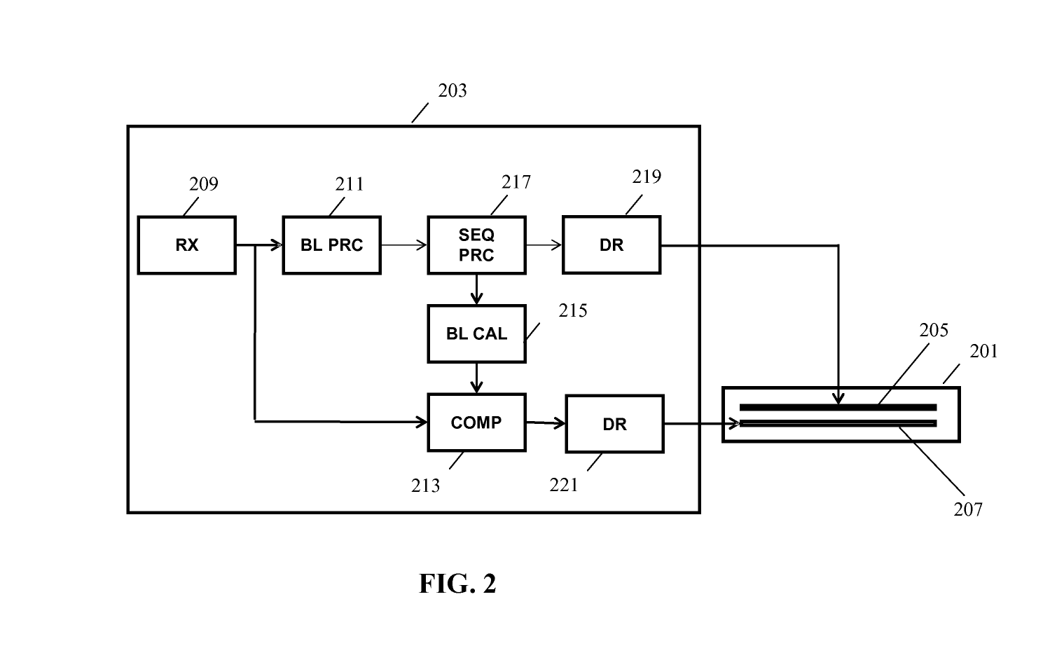

FIG. 2 illustrates an example of a display system in accordance with some embodiments of the invention. The display system comprises a display 201 driven by a display driver 203. It will be appreciated that although the display 201 and the display driver 203 are illustrated as separate functional blocks they may be integrated in the same device. Specifically, the display driver 203 and the display 201 may be implemented as a single display unit, such as e.g. a computer monitor or a television.

The display 201 comprises a backlight 205 and a light modulating display panel 207. The backlight 205 provides light which falls on the light modulating display panel 207. The light modulating display panel 207 comprises a number of light modulating elements/pixels, typically arranged as an array of elements, each of which has a transparency that can be controlled. Thus, the light modulating display panel 207 can modulate the incident light from the backlight 205 to change the light transmission of the individual pixels. This pixel modulation allows an image to be rendered. As a typical example, the light modulating display panel 207 may be implemented using Liquid Crystal (LC) technology, and thus the display 201 may specifically be an LC display.

The display 201 of FIG. 2 is a color sequential display and thus the display driver 203 is a display driver for an exemplary color sequential display. The color sequential display 201 displays each image in a plurality of fields where each field is a time interval providing a color primary for the image. Typically each field provides a relatively constant backlight whereas the backlight is changed between the fields to provide the different primaries. The color sequential display may use two, three, four or possible more fields for each image, i.e. the image may be rendered using two, three, four or more primaries. The following description will focus on a three-primary display, i.e. a display where each image is represented in a frame comprising three fields.

In most conventional color sequential displays, predetermined backlight chromaticities are used for each of the fields. Specifically, most color sequential display uses a Red, Green and Blue (RGB) backlight field. In some such displays, the backlight luminance may be varied whereas the luminance in other displays may also be a fixed predetermined value. However, in the system of FIG. 2, the chromaticity in the different fields can be dynamically adapted for the individual image and may thus be optimized for the specific image content. In addition, the luminance may typically be determined to suit the individual image although it will be appreciated that in some embodiments a fixed predetermined luminance may be used.

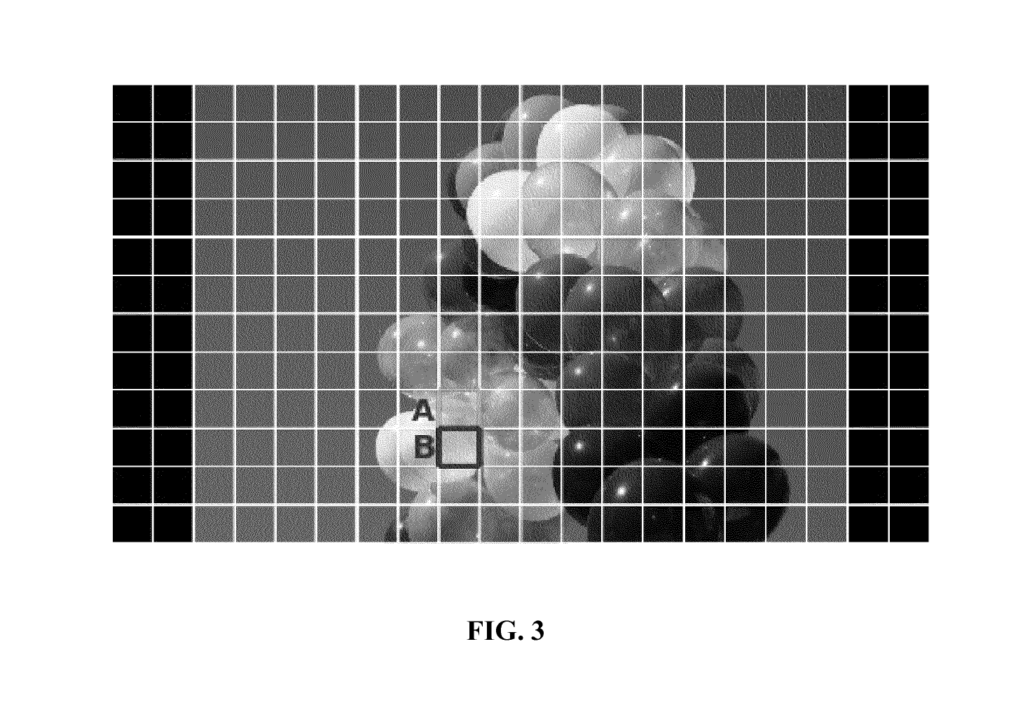

The backlight 205 of FIG. 2 is a segmented backlight which allows the backlight chrominance (chromaticity and luminance) to be set individually for each of a plurality of backlight segments. Thus, as illustrated in the example of FIG. 3, the display is divided into a plurality of backlight segments which each can be set independently. In the display, the backlight segments are substantially larger than the pixels and thus the backlight segment resolution is much lower than the pixel resolution.

The display driver 203 comprises an image receiver 209 which receives the image(s) to be displayed. The image may for example be an image (or frame) of a video signal. The image receiver 209 may receive the image from any internal or external source.

The image receiver 209 is coupled to a backlight processor 211 which is arranged to determine backlight chromaticities for the fields of the image to the image. The backlight processor 211 determines a chromaticity for each field and for each backlight segment of the display (although it will be appreciated that in some embodiments or scenarios only a subset of segments and/or fields may depend on the image content, e.g., in some embodiments a fixed predetermined chromaticity may be used for a subset of fields and/or backlight segments).

The backlight processor 211 may typically also determine a luminance for the fields and/or segments, i.e. chrominance values may be determined. It will be appreciated that any suitable approach, criterion or algorithm for determining suitable chromaticities (or chrominances) for the fields for the specific image content may be used. For example, the prior art approaches presented in F. -C. Lin, Y. Zhang, and E. H. A. Langendijk, “Color Breakup Suppression by Local Primary Desaturation in Field-Sequential Color LCDs”, IEEE J. of Display Technology, 7(2), 2011 may be used.

As a specific example, the backlight processor 211 may determine primary colors (henceforth used to denote the chromaticity or chrominance in each field for a segment) to provide a desired gamut for the input image, or more specifically a suitable gamut for a local image region associated with the backlight segment. For example, the backlight processor 211 may calculate the primary colors required to determine the backlight level for each color field required to represent the image content of the image region corresponding to the backlight segment without clipping (or with the clipping being lower than a given absolute or relative threshold).

The image receiver 209 is further coupled to a modulating processor 213 which is arranged to determine light modulating values for the pixels of the light modulating display panel 207. The light modulating values are determined in response to the image and the backlight determined for the image. In a simple embodiment, the modulating processor 213 may simply determine the light modulating values for each pixel assuming that the backlight incident on the pixel is the same as that emitted by the backlight segment immediately behind the pixel. However in many embodiments, the display driver 203 may be arranged to perform a more complex and accurate calculation of the backlight incident on each pixel. Such a calculation can specifically take into account the spatial cross talk between backlight segments and thus reflects the actual backlight reaching the pixel from the different backlight segments.

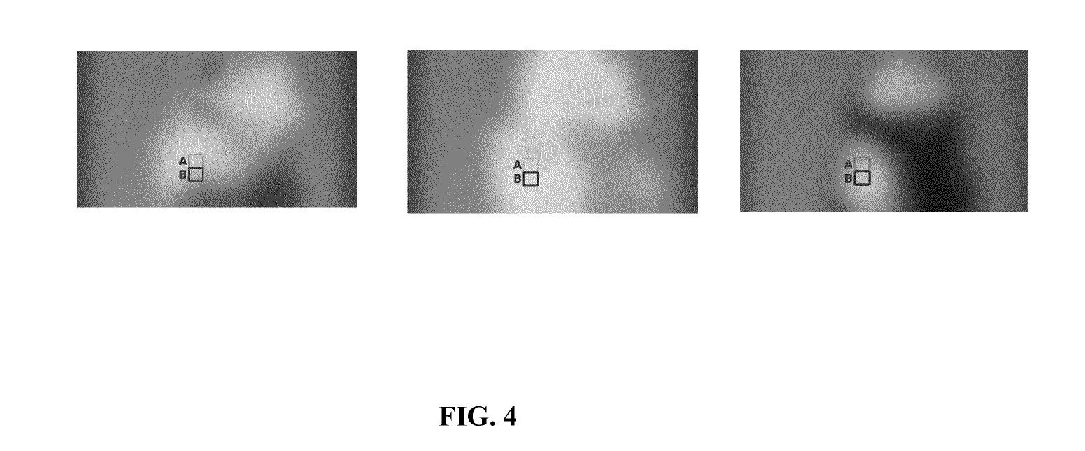

Accordingly, the display driver 203 comprises a backlight calculation unit 215 which calculates the incident backlight on each pixel of the light modulating display panel 207. The backlight calculation is based on the determined primary color values and may for example for each pixel determine a contribution from the backlight segment directly behind the pixel as well as for the neighboring segments thereto. The contribution from each segment may be determined based on the geometrical relationship between the pixel and the segment as well as on the specific primary color values applied in the segment. The backlight calculation is performed for each field and FIG. 4 illustrates an example of the result of such a calculation for a three field/primary color sequential display displaying the image of FIG. 3.

Conventionally, the determined primary color values are used directly to drive the backlight 205 and the calculation of the backlight and the light modulating values are directly calculated based on these primary color values. However, the system of FIG. 2 further performs the operation of temporally arranging the primary colors based on the determined chromaticities. Specifically, the display driver 203 comprises a sequence processor 217 which is coupled to the backlight processor 211 and the backlight calculation unit 215. The sequence processor 217 receives the determined chromaticity values (or in most embodiments the chrominance values) from the backlight processor 211 and proceeds to determine a sequential order of the backlight chromaticities for each of the backlight segments for the image in response to the chromaticities. The backlight processor 211 allocates the determined primary color values to the specific fields of the image depending on the actual chromaticity (and possibly luminance) determined for the individual segments. Thus, rather than merely considering each backlight segment separately, the system of FIG. 2 comprises the additional step of arranging the primary color values temporally in order to improve spatial backlight characteristics. Specifically, the backlight chromaticity calculation may be performed separately for each backlight segment, but the resulting chromaticities may be temporally arranged to provide an improved spatial relationship in the individual fields. Thus, the determined primary colors are not just randomly allocated to the individual fields but are carefully allocated to the individual fields as a function of the chromaticity values.

The approach may be used to improve the image quality of the presented image. In particular, the color break-up and similar artifacts known from traditional color sequential displays can be reduced or avoided.

As a specific example, FIG. 3 illustrates an example of an image with a backlight segmentation into 16 horizontal and 9 vertical segments where each segment can be individually set to provide a given chrominance. Specifically, each segment may be formed by a triplet of LEDs (red, green, and blue) which can be individually controlled for each field. For a conventional color-sequential display using such a setup, the backlight fields would switch through the predetermined and fixed colors of red, green, or blue. Applying local primary chromaticity variation will change the fields into multi-colored fields. Specifically, the light radiation of each of the three LEDs may in each segment be set to provide a desired backlight chrominance.

However, in such a system, the different backlight segments will have different chromaticity values and as the backlight reaching a given pixel may originate from a plurality of backlight segments, cross talk occurs which may change not only the luminance but also the chromaticity of the light incident on the pixel.

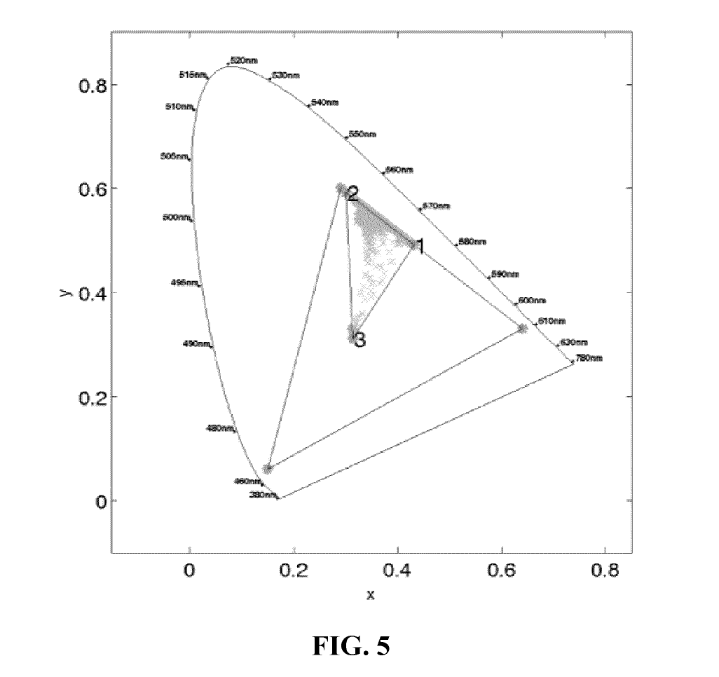

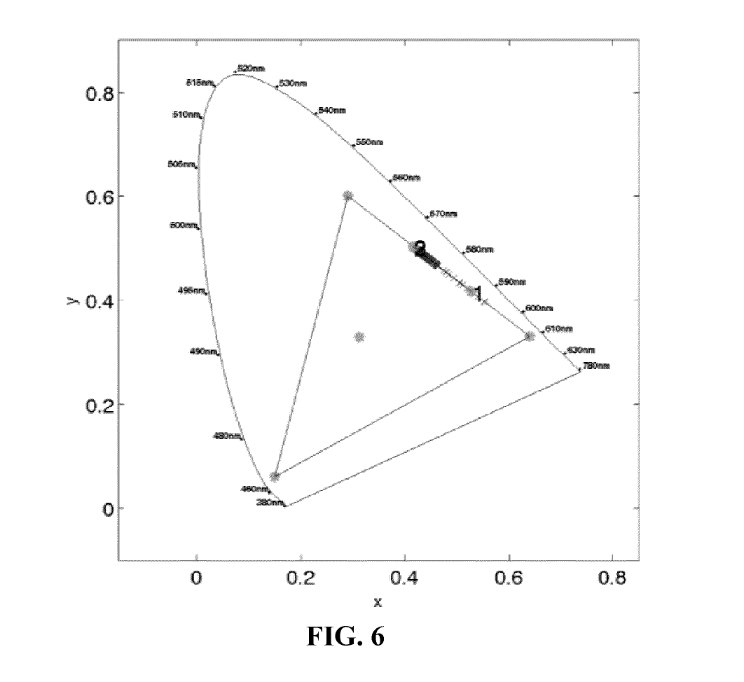

FIG. 4 illustrates examples of the resulting backlight distribution assuming Gaussian light distribution between the LED segments. Furthermore, FIG. 5 illustrates an example of the chromaticity coordinates of the pixels in the A segment indicated in FIGS. 3 and 4, and FIG. 6 illustrates an example of the chromaticity coordinates of the pixels in the B segment. FIGS. 5 and 6 furthermore illustrate the chromaticity values selected by the backlight processor 211 for fields 1, 2 and 3 for the presentation of the image. For segment A, the backlight processor 211 has selected three chromaticity values close to yellow, green and white resulting in a triangle gamut as illustrated inn FIG. 5. For segment B, the backlight processor 211 has selected three chromaticity values close to orange, yellow and yellow resulting in a substantially one dimensional gamut as illustrated in FIG. 6.

In a conventional system, the backlight may accordingly during the first field be set to yellow in segment A and orange in segment B, during the second field be set to green in segment A and yellow in segment B, and during the third field be set to white in segment A and yellow in segment B. However, the inventors have realized that such an approach can be improved upon by making the allocation of the determined chromaticities to the fields be dependent on the chromaticities. For example, in the specific (simple) example, improved image quality may be achieved by allocating one of the yellows for segment B to the first field such that both segment A and segment B have chromaticities close to yellow in this field. This may substantially reduce the chromaticity cross talk in the field.

Thus, in the system of FIG. 2, a sequential order of the background chromaticities for each segment is determined on the basis of the determined background chromaticities for the image. Thus, the temporal allocation of chromaticities to fields for the backlight segments is used to reduce spatial cross talk between the backlight segments. This approach has been found to provide a substantial quality improvement in many scenarios. Specifically, it has been found to substantially reduce perceived color break-up.

The selected primary colors and the sequential order, i.e. the allocation of the individual selected primary colors to the individual fields, are fed to the backlight calculation unit 215 which accordingly proceeds to determine the backlight incident on each pixel in each field. The selected primary colors and the sequential order is furthermore fed to a backlight driver 219 which proceeds to generate a backlight drive signal which is fed to the backlight 205 of the display 201. The backlight drive signal may for example be a data signal indicating the primary color values (chromaticity or chrominance as appropriate) or may e.g. be a direct electrical signal (or signals). For example, the backlight drive signal may in some embodiments be directly coupled to the backlight LEDs and drive these.

Similarly, the modulating processor 213 is coupled to a modulation driver 221 which is arranged to generate a drive signal for the light modulating display panel 207. Similarly to the backlight drive signal, the light modulating drive signal may e.g. be a data signal indicating the pixel values/ transmitivity or may e.g. be a direct electrical signal (or signals). For example, the backlight drive signal may in some embodiments be directly coupled to the LC pixels of the light modulating display panel 207.

As described, the system of FIG. 2 applies an improved field ordering in order to remove or reduce artifacts from a display based on color-sequential principles in combination with local backlight chromaticity adaptation. The field re-ordering of chromaticities is performed after the determination of the segment chromaticities but before the determination of the backlight incident on the pixels. This allows a low complexity and low computational resource demand as it allows the chromaticities to be determined separately for each backlight segment while at the same time allowing some chromaticity alignment between the backlight segments.

The approach may specifically reduce content breakup artifacts such as sharp lines in uniform regions. Indeed, it has been found that in traditional approaches, the modulation of the LC-panel will cause sharp edges to appear when the eye of the observer is moving relative to the screen, for example if one makes an eye movement across the screen. This artifact, which is related to color breakup, is specific for color-sequential systems with variable chromaticity for different backlight segments. The inventors of the current invention have not only realized this problem but also realized that it may be mitigated by a structured temporal arrangement of the different chromaticities.

The approach may also mitigate the image de-saturation which occurs in the conventional approach due to spatial cross-talk between backlight segments with different chromaticities. The approach may also typically reduce color breakup.

It will be appreciated that the specific criterion or approach used to determine the sequential order of the primary colors (and specifically the backlight chromaticities) will depend on the requirements and preferences of the specific embodiment.

In many embodiments, the sequential order for a given segment may depend only on the primary colors (and specifically the backlight chromaticities) determined for that segment. In other embodiments, the sequential order for a given segment may (also) be determined in response to chromaticities of one or more other segments, such as specifically in response to one or more neighbor segments.

In many such embodiments, the sequential order is arranged to determine an indication of a cross talk between neighboring segments for the different allocations of the primary colors to the fields. For example, for a first field of a first segment, a given primary color may be allocated. For a neighboring second segment, the chromaticity difference between each primary color of the first segment and all the primary colors of the second field may be calculated. The cross talk indication for each combination of the primary colors of the first and second segment may then be calculated by weighting the determined chromaticity difference (or distance) by the luminance of the primary colors of the combination. The combinations of the primary colors that result in the lowest accumulated cross talk indication may then be selected.

Ideally, such calculations and selections are performed jointly such that a global and complete optimization is performed resulting in a minimization of global cross talk. However, such an approach is typically far too complex and resource demanding. Therefore, typically algorithms or approaches can be used which may be based on more local or part optimizations. E.g. the allocation of primary colors to fields may be performed such that pairwise cross talk between segments is individually minimized.

Thus, in many embodiments the determination of the sequential order for one segment may include consideration of the primary colors of other segments. Typically, it is not necessary to consider more than the adjacent segments, as spatial cross-talk between far-away segments is typically limited. For every segment, it would be desirable to consider all immediate neighbor segments in order to determine the best color order. However, as the selection for each segment depends on the choices for other segments, a very complex optimization problem exists. This may for example be addressed by performing iterative optimizations where the sequential order is determined in a number of passes with each pass being based on the selections of the previous iteration. However, such an approach may be time demanding and computationally demanding. In some embodiments, a single pass may be used, e.g. starting in the upper left corner and scanning through the backlight segments. In such an approach the sequential order for each segment may be determined on the basis of the adjacent segments for which a sequential order has already been determined while ignoring segments for which no sequential order has yet been determined. Such a single pass may in many scenarios provide sufficient image quality while maintaining a low computational resource usage.

In other embodiments, computational resource usage may be reduced by other approaches for implicitly selecting sequential orders resulting in minimized or reduced spatial cross talk. Such an approach may specifically be based on selecting the sequential order for each backlight segment based on the primary colors (chromaticities) of only the backlight segment itself.

Such an approach may specifically be based on comparing the determined chromaticities to a chromaticity reference. Specifically, the sequential order of the chromaticities may for each individual segment be arranged in order of increasing (or decreasing) distance to the chromaticity reference. If this approach is used for all backlight segments, a reduced cross talk will be achieved as similar chromaticities will tend to be allocated to the same fields. The chromaticity reference may for example be a chromaticity point or a chromaticity vector.

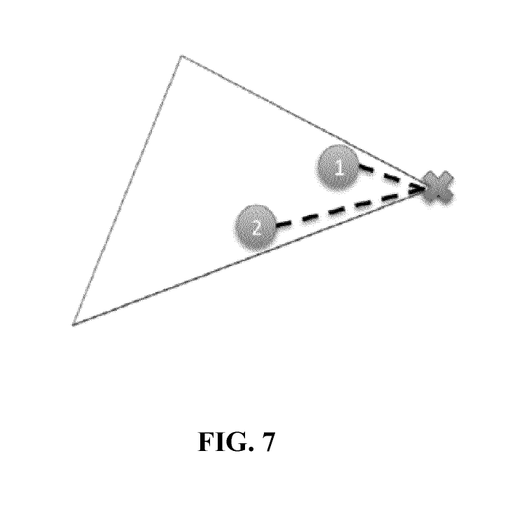

As an example, a specific algorithm may be based on N−1 reference colors for an N-primary system. These colors are indexed from 1 to N−1. For each segment, segment backlight chromaticity closest to the first reference color is assigned to the first field. Of the remaining segment colors, the color closest to the second reference color is assigned to the second field, etc. For a 2-field color-sequential system with 1 reference color, e.g. red, this means that the reddest segment color is always located in the first field as illustrated in FIG. 7 which shows the allocation of two chromaticities to fields 1 and 1 in order of increasing distance.

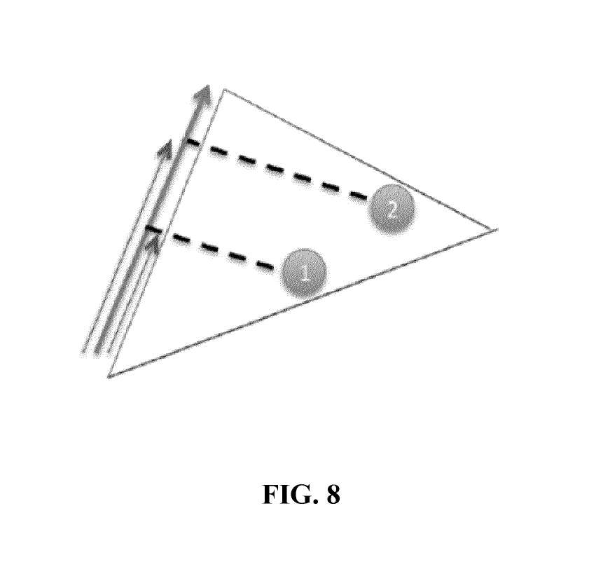

Another efficient method is based on a pre-defined vector, for example the chromaticity coordinate y. The primary with the lowest chromaticity coordinate y is assigned to the first field, the one with the second lowest chromaticity coordinate is assigned to the second field, etc. It is of course possible to replace the chromaticity coordinate y with any vector, including vectors that do not have starting point in origo. An example of using the vector between the blue and green primary for a 2-field color-sequential system is shown in FIG. 8.

Rather than using a pre-defined vector, the vector may in some embodiments be adapted to the image, e.g. based on the determined chromaticities or perhaps on the color points in the image. Using a new vector for each frame could make the method more robust when several primaries are almost orthogonal to the vector, but yet different in color.

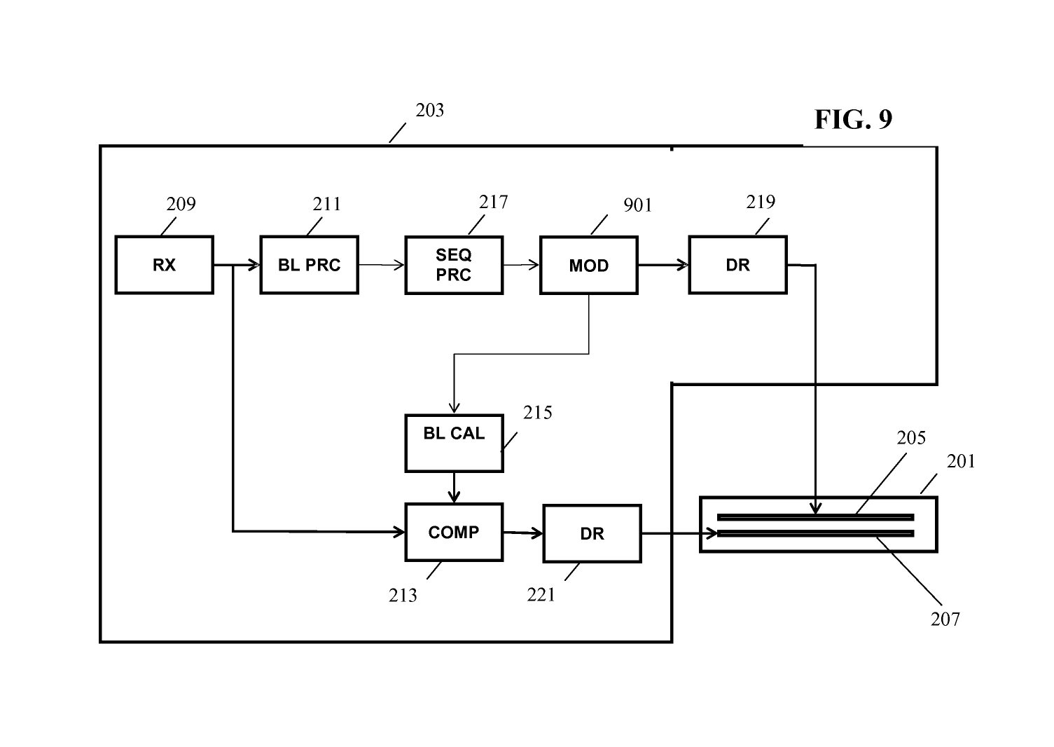

In some embodiments, the display driver 203 may be arranged to modify one or more of the determined chromaticities following the temporal ordering of the chromaticities. An example of a display system comprising such a display driver 203 is illustrated in FIG. 9. The system corresponds to the systems of FIG. 2 except that the display driver 203 further comprises a primary modifier 901 coupled between the sequence processor 217 and the backlight calculation unit 215 and the backlight driver 219. The primary modifier 901 is arranged to modify at least a first chromaticity of the chromaticities in response to the sequential order.

In some embodiments, the primary modifier 901 may be arranged to change the chromaticity of one of the fields such that the cross talk is reduced. For example, if, following the ordering of the chromaticities, it is found that two adjacent backlight segments have chromaticities that are very far from each other, one or both of the chromaticities may be modified such that the two segments are closer to each other.

In some embodiments, the primary modifier 901 may be arranged to modify a luminance of one of the primary colors in response to the determined chromaticities and/or the sequential order. For example, in the previous specific example, the sequential order for a first segment was determined as yellow, green, and white whereas the sequential order for a second segment was determined as yellow, yellow, and orange. In this example, the primary modifier 901 may reduce the luminance of the yellow in the second field of the second segment, and may in particular completely switch off the yellow in the second field. The reduced light output may be compensated by increasing the luminosity of the backlight in the first field of the second segment and/or by increasing the transmittivity of the pixels in the first field. Thus, the luminance may be reduced for a first chromaticity with a corresponding increase for another chromaticity being sufficiently close to the first chromaticity. The approach may reduce the spatial cross-talk and the de-saturation associated therewith. For example, the saturation of green colors may be increased due to the reduced de-saturation caused by cross-talk between the segments in the second field.

The approach may thus utilize a sequential three stage optimization of the backlight. In the first stage, suitable backlight primary values may be found for each backlight segment. This determination may be based on local considerations thereby allowing a relatively low complexity and low resource demand. Based on the output of the first stage, the display driver may then proceed to perform a temporal arranging of the determined primaries in order to reduce cross talk between different segments. At the end of the second stage, the system has thus determined which primary colors to use in each field and each backlight segment. The system may then optionally consider whether any backlight chromaticities or luminances can be modified to improve performance. Thus, rather than perform a complete total optimization which is impractical, the system can apply a specific sequence of partial/local optimizations. This results in a substantial complexity reduction allowing a practical application while at the same time providing a high image quality of the displayed image.

In some embodiments, the sequence processor 217 is arranged to determine the sequential order in response to backlight chromaticities and/or the sequential order determined for other images. Specifically, the sequential order may be determined in response to the chromaticities (and the order thereof) in the previous (or following) image(s) of an image sequence, such as a video sequence.

Displays with adaptive backlights, such as systems with local-primary de- saturation, are typically susceptible to temporal instability. Often temporal filters are applied in order to temper the very dynamic behavior of such an adaptive backlight. If the segment fields are not optimally re-ordered, segment colors can become mixed across temporal fields due to the temporal filters, which would lead to wrong color points.

The sequence processor 217 may accordingly contain a frame memory storing the backlight segment colors chosen for either previous and/or future frames. These may then be considered when selecting the primary colors for the current frame. For example, the sequence may be selected to correspond to the sequence of the previous images if the chromaticities of the segment are sufficiently similar. This can avoid in-consistent field ordering between frames thereby reducing image flickering.

If the sequential order of the determined chromaticities is determined based on comparison with one (or more) chromaticity references, temporal consistency is generally quite good. Temporal filtering is in this case an option. If the field ordering has been obtained by using complex optimization, temporal stability could be a problem. To improve temporal stability, the order of the complex optimization may be constrained by simple rules, such as comparison with one (or more) chromaticity references. Imposing such strong constrains limits the freedom of the optimization. Alternatively, the chromaticity of a field at a particular spatial location in the previous frame could be used to constrain the optimization at the same location in the frame to be processed. In this way, the constraints are spatially (and temporally) varying and matched to the image content, allowing the optimization more freedom.

In some embodiments and scenarios, a combined adaptation of luminance and chromaticity may be performed. For example, if two almost identical primaries are combined, these may be replaced by a single third chromaticity and luminance. The third chromaticity and luminance may provide a new primary e.g. corresponding to the average color of the originally determined primaries.

It will be appreciated that the described principles and approaches may be applied to three primary color sequential displays as described but may equally be applied to e.g. two primary color sequential displays or color sequential displays having more than three primaries (also known as multi-primary color sequential displays). It is also noteworthy that the described methods can be applied in different color spaces, including chromaticity spaces, CIE-XYZ, and RGB color spaces.

It will be appreciated that the above description for clarity has described embodiments of the invention with reference to different functional circuits, units and processors. However, it will be apparent that any suitable distribution of functionality between different functional circuits, units or processors may be used without detracting from the invention. For example, functionality illustrated to be performed by separate processors or controllers may be performed by the same processor or controllers. Hence, references to specific functional units or circuits are only to be seen as references to suitable means for providing the described functionality rather than indicative of a strict logical or physical structure or organization.

The invention can be implemented in any suitable form including hardware, software, firmware or any combination of these. The invention may optionally be implemented at least partly as computer software running on one or more data processors and/or digital signal processors. The elements and components of an embodiment of the invention may be physically, functionally and logically implemented in any suitable way. Indeed the functionality may be implemented in a single unit, in a plurality of units or as part of other functional units. As such, the invention may be implemented in a single unit or may be physically and functionally distributed between different units, circuits and processors.

Although the present invention has been described in connection with some embodiments, it is not intended to be limited to the specific form set forth herein. Rather, the scope of the present invention is limited only by the accompanying claims. Additionally, although a feature may appear to be described in connection with particular embodiments, one skilled in the art would recognize that various features of the described embodiments may be combined in accordance with the invention. In the claims, the term comprising does not exclude the presence of other elements or steps.

Furthermore, although individually listed, a plurality of means, elements, circuits or method steps may be implemented by e.g. a single circuit, unit or processor. Additionally, although individual features may be included in different claims, these may possibly be advantageously combined, and the inclusion in different claims does not imply that a combination of features is not feasible and/or advantageous. Also the inclusion of a feature in one category of claims does not imply a limitation to this category but rather indicates that the feature is equally applicable to other claim categories as appropriate. Furthermore, the order of features in the claims do not imply any specific order in which the features must be worked and in particular the order of individual steps in a method claim does not imply that the steps must be performed in this order. Rather, the steps may be performed in any suitable order. In addition, singular references do not exclude a plurality. Thus references to “a”, “an”, “first”, “second” etc do not preclude a plurality. Reference signs in the claims are provided merely as a clarifying example shall not be construed as limiting the scope of the claims in any way.

1. An apparatus for driving a color sequential display (201) for displaying at least one image, the apparatus having a backlight (205) comprising a plurality of backlight segments each associated with a region of the image, and a light modulating panel (207) comprising pixels having controllable light transmission for modulating light from the backlight (205), the apparatus comprising:
a backlight unit (211) for determining, for each of theft plurality of backlight segments, backlight chromaticities for fields of the image based on a gamut of the image region associated with the respective backlight segment;
an order unit (217) for determining a sequential order of the backlight chromaticities for each of the plurality of backlight segments for the at least one image such that the differences in backlight chromaticities for adjacent backlight segments within a field are reduced;
a first driver (219) for generating a backlight drive signal for the backlight (205) corresponding to the backlight chromaticities and the sequential order;
a modulating processor (213) for determining light modulating values for the pixels in response to the chromaticities, the sequential order and the at least one image; and
a second driver (221) for generating a light modulating drive signal for the light modulating panel corresponding to the light modulating values.

2. The apparatus of claim 1 wherein the order unit (217) is arranged to determine the sequential order for a first backlight segment of the backlight segments by comparing the backlight chromaticities of the first backlight segment to the backlight chromatities of at least one neighboring backlight segment and chosing the sequential order for the first backlight segment such that the differences between the two backlight chromaticities within a field are reduced.

3. (canceled)

4. The apparatus of claim 2 wherein the order unit (217) is arranged to determine the sequential order for a first backlight segment of the backlight segments in response to a comparison between the chromaticities of the first backlight segment and a chromaticity reference.

5. The apparatus of claim 3 wherein the chromaticity reference is a chromaticity point.

6. The apparatus of claim 3 wherein the chromaticity reference is a chromaticity vector.

7. (canceled)

8. The apparatus of claim 1 wherein the order unit (217) is arranged to determine the sequential order to minimize spatial cross talk between at least two neighboring backlight segments of the backlight segments in at least one field.

9. The apparatus of claim 1 wherein the order unit (217) is arranged to determine the sequential order also in response to backlight chromaticities determined for a previous image.

10. (canceled)

11. The apparatus of claim 1 further comprising a modification unit (901) for modifying at least a first backlight chromaticity of the backlight chromaticities such that the differences in backlight chromaticities for adjacent backlight segments are further reduced.

12. The apparatus of claim 1 where the modification unit (901) is arranged to also modify a backlight luminance associated with the first chromaticity.

13. (canceled)

14. A color sequential display system comprising:
a display (201) for displaying at least one image, the display having a backlight (205) comprising a plurality of backlight segments each associated with a region of the image and a light modulating panel (207) comprising pixels having controllable light transmission for modulating light from the backlight (205);
a backlight unit (211) for determining, for each of the plurality of backlight segments, backlight chromaticities for fields of the image based on a gamut of the image region associated with the respective backlight segment;
an order unit (217) for determining a sequential order of the backlight chromaticities for each of the plurality of backlight segments for the at least one image such that the differences in backlight chromaticities for adjacent backlight segments within a field are reduced.
a first driver (219) for generating a backlight drive signal for the backlight (205) corresponding to the backlight chromaticities and the sequential order;
a modulating processor (213) for determining light modulating values for the pixels in response to the chromaticities, the sequential order and the at least one image; and a second driver (221) for generating a light modulating drive signal for the light modulating panel (207) corresponding to the light modulating values.

15. A method of driving a color sequential display (201) having a backlight (205) comprising plurality of backlight segments and a light modulating panel (207) comprising pixels having controllable light transmission for modulating light from the backlight (205); the method comprising:
determining, for each of a plurality of backlight segments, backlight chromaticities for fields of at least one image to be displayed by the color sequential display (201) based on the gamut in an associated region of the at least one image;
determining a sequential order of the backlight chromaticities for each of the plurality of backlight segments for the at least one image in response to the chromaticities;
generating a backlight drive signal for the backlight (205) corresponding to the backlight chromaticities;
determining light modulating values for the pixels in response to the chromaticities, the sequential order and the at least one image; and
generating a light modulating drive signal for the light modulating panel (207) corresponding to the light modulating values.
